(19) United States
(12) Patent Application Publication
(10) Pub. No.: US 2024/0092153 A1
(43) Pub. Date: Mar. 21, 2024

(54) MOTOR VEHICLE PROVIDED WITH AN IMPROVED CAR DOOR

(71) Applicants: Fabrizio FERRARI, Formigine (IT); Sator SRL, Sassuolo (IT)

(72) Inventor: Fabrizio FERRARI, Formigine (IT)

(73) Assignees: Fabrizio FERRARI, Formigine (IT); Sator SRL, Sassuolo (IT)

(21) Appl. No.: 18/274,469

(22) PCT Filed: Nov. 10, 2022
(86) PCT No.: PCT/IB2022/060816

§ 371 Date: Jul. 27, 2023

(30) Foreign Application Priority Data
Nov. 17, 2021 (IT) 102021000029072

(51) Int. Cl. B60J 5/04; B60J 1/14; E05D 15/02

(52) U.S. Cl. CPC B60J 5/047; B60J 1/14; E05D 15/02; E05Y 2201/682; E05Y 2201/684; E05Y 2900/531; E05Y 2900/55

(57) ABSTRACT

The motor vehicle (1) provided with an improved car door comprises:
one basic chassis (2);
a plurality of wheels (3) movable along one anteroposterior direction (A);
one compartment (4a, 4b);
one car door (5) associated with the basic chassis (2) so as to be rotatable around one axis of rotation (R) horizontal and orthogonal to the anteroposterior direction (A);
   wherein:
the car door (5) comprises one opening door (6) provided with a first side (7) rectilinear in shape and with a second side (8), associated with the first side (7), shaped in a semi-circumference;
the motor vehicle (1) comprises one guiding and movement assembly (10, 11) adapted to move the car door (5) between one closing configuration, wherein the first side (7) is arranged horizontal, and at least one opening configuration, wherein the first side (7) is arranged vertical.

### TECHNICAL FIELD

The present invention relates to a motor vehicle provided with an improved car door.

### BACKGROUND ART

As is well known, motor vehicles are traditionally provided with opening and closing car doors which allow one or more passengers, such as e.g. the driver, to enter/exit the compartment due to their opening and, at the same time, to insulate the passenger compartment from the outside due to their closing.

In this case, the opening and closing of the car doors are typically made possible by one or more hinges mounted on the chassis of the motor vehicle and to which the car doors themselves are associated in a rotatable manner.

In this regard, a first and particularly common type of motor vehicle comprises car doors which can be rotated around a vertical axis.

In actual facts, to allow entry/exit into/from the compartment in this type of motor vehicles, it is necessary to pull the car doors from the outside or, in the same way, to push them from the inside to set them in rotation around the hinges and, in this way, allow them to be opened.

Similarly, by pushing such car doors from the outside or, in the same way, by pulling them from the inside, it is possible to close them and thereby insulate the compartment from the outside.

This common type of motor vehicles is, however, affected by many drawbacks and is, therefore, amenable to improvements aimed at increasing, especially, the practicality with which one or more passengers can get in and out of it.

Considering the operation just described, in fact, it is easy to appreciate that opening the doors of these motor vehicles requires sufficiently large spaces around the vehicle itself to be done properly.

For example, in the case where the motor vehicle is parked in particularly small areas, opening the car door from the inside may be only partly possible, inconveniently complicating the exit from the compartment, or it may not even be possible at all, forcing one to look for a different and, in particular, wider parking space in which to move.

Not only that, but even assuming that the motor vehicle had adequate space available to allow the passenger to get in/out, the car door could still hit an obstacle in its opening stroke and, in doing so, be damaged.

To solve at least part of the aforementioned problems, motor vehicles built in accordance with the teachings of patent CN200961412Y are known.

This document illustrates, in the present case, a motor vehicle provided with a hemispherical compartment having an entrance shaped as a circular quadrant and a car door, associated with the chassis of the motor vehicle in a rotatable manner, also shaped as a circular quadrant in a manner quite similar to the entrance to the compartment.

The car door of the motor vehicle illustrated in patent CN200961412Y is, in particular, associated with the chassis of the motor vehicle so that it can rotate around a horizontal axis perpendicular to the anteroposterior direction of standard travel of the motor vehicle.

Thus, in this way, it is possible to rotate the car door by 90° in one direction or in the other around that axis of rotation to overlap or set it alongside the entrance to the compartment, thus preventing or allowing access thereto from the outside respectively.

The motor vehicle described in patent CN200961412Y clearly allows the previously mentioned problems concerning car doors with a vertical axis of rotation to be solved because, in this case, no additional space around the motor vehicle is required to be able to open and close the car door in a suitable manner.

Nevertheless, the above patent is also susceptible to various improvements.

Firstly, it is noted that the motor vehicle described in patent CN200961412Y is provided with a car door manufactured and engineered in a rather rudimentary manner as well as operating in a rather imprecise manner.

As proof of this, such a motor vehicle is totally lacking any system for guiding and controlling the car door that would allow the latter to move smoothly and, at the same time, accurately.

This causes, inevitably, unstable operation of the car door, which results, e.g., in considerable and inconvenient swaying/vibration when the motor vehicle is in motion.

Not only that, but motor vehicles built in accordance with the teachings of the CN200961412Y patent are aesthetically unappealing and unsatisfactory, thus reducing the interest of many consumers in purchasing them.

### DESCRIPTION OF THE INVENTION

The main aim of the present invention is to devise a motor vehicle provided with an improved car door which allows, even when parked in particularly narrow spaces, smooth, practical and functional access/exit into/from the passenger compartment by minimizing, in particular, the risk of the car door impacting against an obstacle in its opening stroke.

Within that main aim, the object of the present invention is to devise a motor vehicle provided with an improved car door which is deemed aesthetically valuable and appealing to consumers and thereby stimulates them to purchase it.

It is an additional object of the present invention to devise a motor vehicle provided with an improved car door that enables the aforementioned main aim to be solved in the context of symmetrical motor vehicles that can be driven in both directions, so-called “bidirectional”.

Another object of the present invention is to devise a motor vehicle provided with an improved car door that allows the aforementioned drawbacks of the prior art to be overcome within the framework of a simple, rational, easy-to-use and cost-effective solution.

The aforementioned objects are achieved by this motor vehicle provided with an improved car door having the characteristics of claim 1.

### BRIEF DESCRIPTION OF THE DRAWINGS

Other characteristics and advantages of the present invention will become more apparent from the description of a preferred, but not exclusive, embodiment of a motor vehicle provided with an improved car door, illustrated by way of an indicative, yet non-limiting example, in the accompanying tables of drawings in which:

FIG. 1 is an axonometric view of the motor vehicle according to the invention;

FIG. 2 is a side view of the motor vehicle according to the invention with the car door in the closing configuration;

FIG. 3 is a side view of the motor vehicle according to the invention with the car door in the first opening configuration;

FIG. 4 is a side view of the motor vehicle according to the invention with the car door in the second opening configuration;

FIG. 5 is an exploded view of the motor vehicle according to the invention.

### EMBODIMENTS OF THE INVENTION

With particular reference to these figures, reference numeral 1 globally indicates a motor vehicle provided with an improved car door.

The motor vehicle 1 provided with an improved car door comprises at least one basic chassis 2 and at least one plurality of wheels 3 associated with the basic chassis 2 and movable along at least one anteroposterior direction A for the forward movement of the motor vehicle 1.

Preferably, the motor vehicle 1 comprises four wheels 3.

In the present case, the four wheels 3 are arranged with respect to the basic chassis 2 at points opposite each other and in a manner quite similar to what occurs in a conventional motor vehicle provided with four wheels.

A motor vehicle 1 cannot however be ruled out provided with a different number of wheels 3 associated with the basic chassis 2 such as, e.g., a motor vehicle 1 provided with five or more wheels 3.

Conveniently, the motor vehicle 1 has at least one motorized unit, not shown in the figures for simplicity sake.

Preferably, the motor vehicle 1 is provided with four motorized units, each associated with a respective wheel 3.

In accordance with the preferred embodiment, the motorized units are of the electric motor type.

Different engine solutions for the motor vehicle 1 cannot however be ruled out. For example, a different number and/or a different type (e.g. of the internal combustion type) and/or a different location of the motorized units cannot be ruled out.

The motor vehicle 1 then comprises at least one compartment 4a, 4b intended to accommodate at least one passenger P and at least one car door 5 associated with the basic chassis 2 in a rotatable manner around at least one axis of rotation R substantially horizontal and orthogonal to the anteroposterior direction A.

According to the invention, the car door 5 comprises at least one opening door 6 provided with at least a first side 7 substantially rectilinear in shape and with at least a second side 8, associated with the first side 7, substantially shaped in a semi-circumference.

In particular, the ends of the first side 7 are made to mate the ends of the second side 8 to define an opening door 6 substantially shaped in a semi-circle.

Furthermore, according to the invention, the motor vehicle 1 comprises at least one guiding and movement assembly 10, 11 associated with the basic chassis 2 and adapted to move the car door 5 between at least one closing configuration, wherein the first side 7 is arranged substantially horizontal, and at least one opening configuration, wherein the first side 7 is arranged substantially vertical. Specifically, the guiding and movement assembly 10, 11 comprises at least one circular rail 10 with which the second side 8 is associated in a sliding manner between the opening configuration and the closing configuration.

In this regard, it is specified that, in the context of this disclosure, the term “circular” is meant to designate a circular sector conformation having an angle at the center between 180° and 360°.

In other words, the term “circular” is intended to comprise any circular sector, the angular width of which is between that of a semi-circle and that of a full circle.

Conveniently, the circular rail 10 is formed into the basic chassis 2 and the car door 5 is fitted into the circular rail 10 in a sliding manner.

A circular rail 10 of a different type cannot however be ruled out, e.g., consisting of a circular ring fixed externally onto the basic chassis 2, or consisting of yet other technical solutions that allow, in all cases, smooth and efficient movement between the opening configuration and the closing configuration.

In accordance with the preferred embodiment shown in the figures, the circular rail 10 has a full circle conformation.

In this regard, the curvature of the second side 8 is substantially coincident with the curvature of the circular rail 10.

It is specified that “curvature” refers, in this disclosure, to the degree of deviation from straightness, which is geometrically corresponding to the reciprocal of the radius of curvature.

It is worth noting at this point that the particular expedient of providing a circular rail 10 allows for a particularly stable operation of the car door 5, averting any oscillations/vibrations when the motor vehicle 1 is in motion.

Then, the guiding and movement assembly 10, 11 comprises at least one rotational pin 11 around the axis of rotation R to which the first side 7 is hinged. Precisely, the rotational pin 11 is arranged in a median position along the first side 7.

This evidently allows the car door 5 to be moved between the opening configuration and the closing configuration precisely, efficiently and smoothly.

The car door 5, then, comprises at least one window 12 which is associated with at least one of either the opening door 6 or the guiding and movement assembly 10, 11 and is movable between the closing configuration and the opening configuration.

In particular, the window 12 is provided with at least a first stretch 13 which is shaped substantially straight.

In detail, the first stretch 13 has length substantially coinciding with the first side 7.

Conveniently, the first stretch 13 overlaps substantially mating the first side 7 in the opening configuration and in the closing configuration.

This means that the first stretch 13 and the first side 7 are arranged parallel to each other in the opening configuration and in the closing configuration and are incident to each other in the switch from the opening configuration to the closing configuration.

Conveniently, the first stretch 13 is hinged to the rotational pin 11.

To be precise, the rotational pin 11 is arranged in the median position along the first stretch 13.

In other words, the rotational pin 11 is simultaneously hinged to the first stretch 13 and to the first side 7.

In addition, the window 12 comprises at least a second stretch 14 which is associated with the first stretch 13 and which is substantially shaped in a semi-circumference.

In detail, the second stretch 14 has length substantially coinciding with the second side 8.

Again, the second stretch 14 has substantially the same curvature as the second side 8.

Similarly to what was said about the opening door 6, the ends of the first stretch 13 are made to mate the ends of the second stretch 14 to define a window 12 substantially shaped in a semi-circle.

In actual facts, the window 12 and the opening door 6 have substantially the same semi-circular shape.

In addition, the second stretch 14 is associated with the circular rail 10 in a sliding manner between the closing configuration and the opening configuration.

Taking into consideration that the second stretch 14 has substantially the same curvature as the second side 8, it is easy to appreciate that the curvature of the second stretch 14 is substantially coincident with the curvature of the circular rail 10.

By virtue of its shape, therefore, the second stretch 14 overlaps substantially mating the second side 8 in the opening configuration.

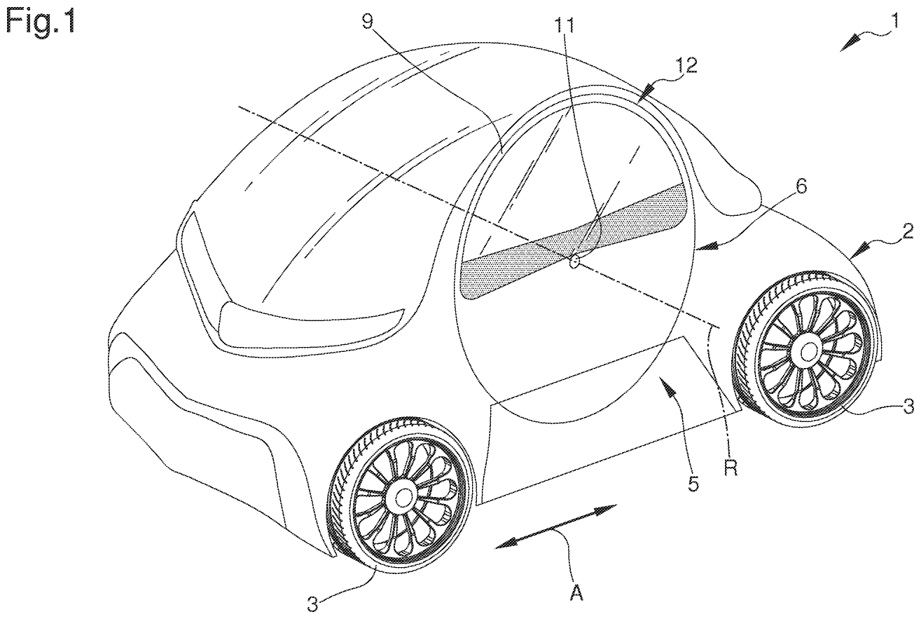

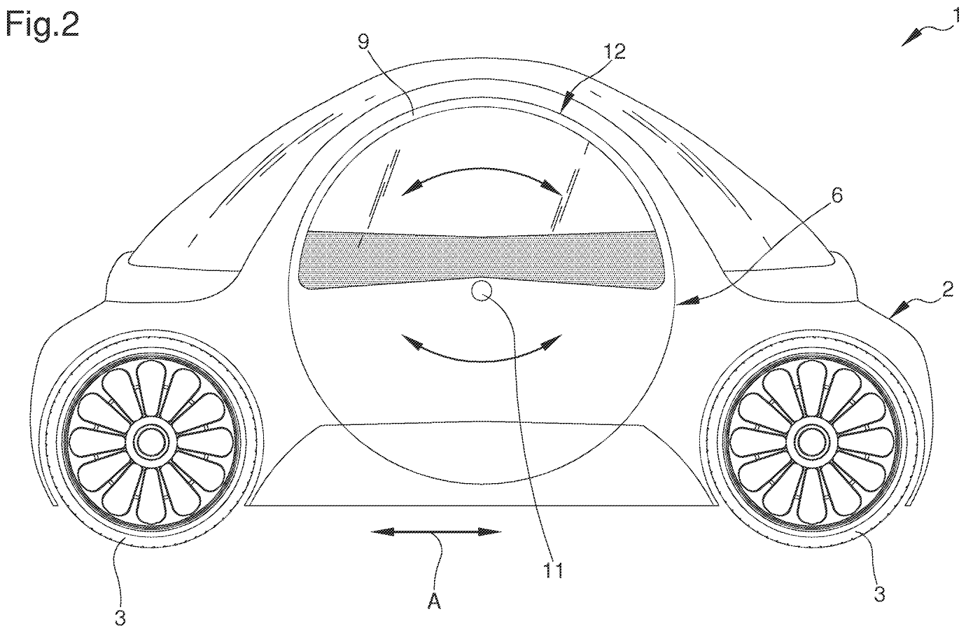

For the same reason, as visible in FIG. 1 and FIG. 2, the second stretch 14 is alongside the second side 8 in the closing configuration to define a complete circumference with the second side 8.

This advantageously allows the compartment 4a, 4b to be efficiently insulated from the outside when the car door 5 is in the closing configuration and, at the same time, to allow easy and immediate entry into the compartment 4a, 4b to the passenger P when the car door 5 is in the opening configuration.

Conveniently, the car door 5 comprises at least one perimeter element 9 associated with the opening door 6 having the function of structural reinforcement of the opening door 6.

In the present case, the perimeter element 9 is substantially shaped as a semi-circumference.

To be precise, the ends of the perimeter element 9 are substantially mating the ends of the second side 8 to define, with the second side 8, a full circumference.

In actual facts, the perimeter element 9 has curvature substantially equal to the second side 8.

Precisely, the perimeter element 9 has curvature substantially equal to both the second side 8 and to the circular rail 10.

This fact proves to be particularly advantageous for several different reasons.

First, the conformation of the perimeter element 9 allows for a coupling to measure with the window 12, when the car door 5 is in the closing configuration, to substantially define a full semi-circle.

In this way, it is clearly possible to insulate the compartment 4a, 4b from the outside in an efficient and functional manner.

Not only that, but the perimeter element 9 also makes it possible, by rotating on the circular rail 10 integral to the opening door 6, to increase the smoothness of the movement of the opening door itself and of the window 12, thus significantly reducing the oscillations/vibrations produced in the switch from the closing configuration to the opening configuration.

According to a preferred embodiment, the opening door 6 is made to rotate in one way around the axis of rotation R in the switch from the closing configuration to the opening configuration, and the window 12 is simultaneously made to rotate in the opposite way around the axis of rotation R. Precisely, the opening door 6 and the window 12 rotate by 90° in opposite ways to each other in the switch from the closing configuration to the opening configuration.

This means that the opening door 6 rotates by 90° around the axis of rotation R in counterclockwise/clockwise direction, and the window 12 rotates by 90° around the axis of rotation R in clockwise/counterclockwise direction in the switch from the closing configuration to the opening configuration.

Similarly, the opening door 6 rotates by 90° around the axis of rotation R in clockwise/counterclockwise direction and the window 12 rotates by 90° around the axis of rotation R in counterclockwise/clockwise direction in the switch from the opening configuration to the closing configuration.

It cannot be ruled out, in all cases, that the opening door 6 and the window 12 rotate in a different manner in the switch from the closing configuration to the opening configuration.

In this sense, it cannot be ruled out that the opening door 6 rotate in one way around the axis of rotation R, with amplitude of, for example, 90°, and that the window 12 rotate in the same way around the axis of rotation R, with amplitude of, for example, 270°.

In other words, it cannot be ruled out that the opening door 6 and the window 12 rotate equiverse and that the angle of rotation of the window 12 be different from the angle of rotation of the opening door 6 so that the latter can overlap the former in the opening configuration.

The motor vehicle 1 can be conveniently made so that it can be driven in forward gear along only one way of the anteroposterior direction A.

In other words, the motor vehicle 1 made in this way allows movement in one way of the anteroposterior direction A in forward gear and movement in the other way of the anteroposterior direction A only by reversing.

Alternatively, in accordance with the preferred embodiment, the motor vehicle 1 can be constructed as a “bidirectional” motor vehicle.

This means that, in the latter case, the motor vehicle 1 is drivable in forward gear in both ways of the anteroposterior direction A.

In this sense, therefore, the basic chassis 2 comprises at least one front entrance 15a and at least one rear entrance 15b where the passenger P can pass through for accessing the compartment 4a, 4b.

In particular, the front entrance 15a and the rear entrance 15b are substantially shaped in semi-circles and are placed side by side to each other to define at least one circular entrance.

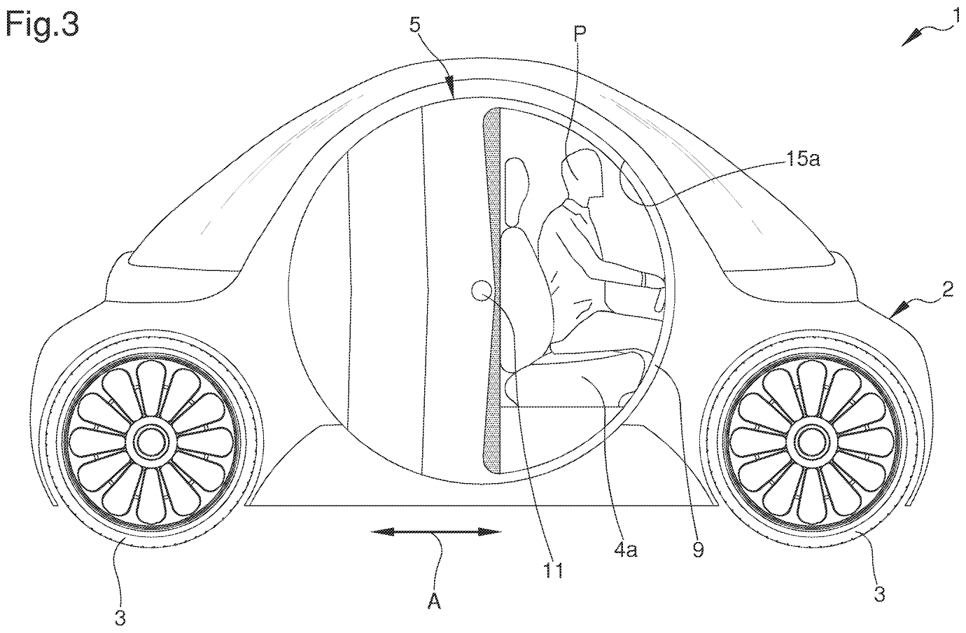

In more detail, as visible in FIG. 3, the compartment 4a, 4b comprises at least one front location 4a that the passenger P can access through the front entrance 15a and at least one rear location 4b that the passenger P can access through the rear entrance 15b.

In this regard, the car door 5 is associated with the circular entrance 15a, 15b and is positionable in at least a first opening configuration wherein it overlaps the rear entrance 15b to allow only the front entrance 15a to pass through, and in at least a second opening configuration wherein the car door 5 overlaps the front entrance 15a to allow only the rear entrance 15b to pass through.

In other words, the car door 5 allows, in the first opening configuration, the access from the outside to the front location 4a only.

Similarly, the car door 5 allows, in the second opening configuration, the access from the outside to the rear location 4b only.

This means that the car door 5 rotates, in one way or the other, around the axis of rotation R by 180° to switch from the first opening configuration to the second opening configuration.

This fact is particularly convenient for a passenger P who wants to access one of either the front location 4a or the rear location 4b as this only needs rotate the car door 5 in one way or the other by 90° with respect to the closing configuration.

Advantageously, the basic chassis 2 comprises at least one vertical upright 16 placed between the front entrance 15a and the rear entrance 15b, the rotational pin 11 being associated with the vertical upright 16 and being arranged in a median position along the vertical upright 16.

Specifically, the vertical upright 16 comprises at least one first end 17 and at least one second end 18 associated with the circular rail 10 in diametrically opposite positions to each other.

Precisely, the vertical upright 16 is arranged in the center of the circular rail 10. It should be noted that the particular arrangement of the first end 17 and of the second end 18 allows the vertical upright 16 to separate the front entrance 15a from the rear entrance 15b and, consequently, the front location 4a from the rear location 4b.

FIG. 6 shows an alternative embodiment of the motor vehicle 1 and, in particular, different from the previous one in that it is provided with a window 12 comprising at least a first portion 12a and at least a second portion 12b rotatable in opposite ways to each other around the axis of rotation R and in that it lacks the vertical upright 16.

In this regard, it is specified that, unless otherwise indicated, the motor vehicle 1 made in accordance with this alternative embodiment is provided with components similar to those listed for the previous embodiment, to the detailed description of which reference is made.

Conveniently, the first portion 12a and the second portion 12b are shaped as circular quadrants.

Specifically, the first portion 12a and the second portion 12b are placed side by side to define a semi-circle when the car door 5 is in the closing configuration.

In this regard, the first portion 12a and the second portion 12b are individually rotatable around the axis of rotation R when the car door 5 is in the closing configuration.

In other words, even only one of either the first portion 12a or the second portion 12b can be rotated around the axis of rotation R when the car door 5 is in the closing configuration.

For example, it is possible to rotate the first portion 12a and the second portion 12b individually by 90° around the axis of rotation R.

The possibility cannot however be ruled out of rotating the first portion 12a and the second portion 12b individually by an angle having a different value, for example, having a value of 180°.

The special expedient of providing a first portion 12a and a second portion 12b that can be individually rotated when the car door 5 is in the closing configuration allows, advantageously, to ventilate only one of either the front location 4a or the rear location 4b without the need, therefore, to open the window 12 completely and ventilate, in so doing, the entire compartment 4a, 4b.

In the switch from the closing configuration to the opening configuration, at least one of either the first portion 12a or the second portion 12b rotates by 180° in one way or the other so that the window 12 overlaps the opening door 6 in the opening configuration to provide access to the compartment 4a, 4b for the passenger P.

To be precise, one of either the first portion 12a or the second portion 12b rotates by 180° in one way in the switch from the closing configuration to the first opening configuration, and the other of either the first portion 12a or the second portion 12b rotates by 180° in the other way in the switch from the closing configuration to the second opening configuration.

It cannot however be ruled out that the first portion 12a and the second portion 12b rotate in a different manner in the switch from the closing configuration to the opening configuration.

For example, it cannot be ruled out that one of either the first portion 12a or the second portion 12b rotate by 180° in one way and the other of either the first portion 12a or the second portion 12b rotate 90° in the opposite way in the switch from the closing configuration to the opening configuration.

In other words, rotations of different amplitude cannot be ruled out of at least one of either the first portion 12a or the second portion 12b in the switch from the closing configuration to the opening configuration.

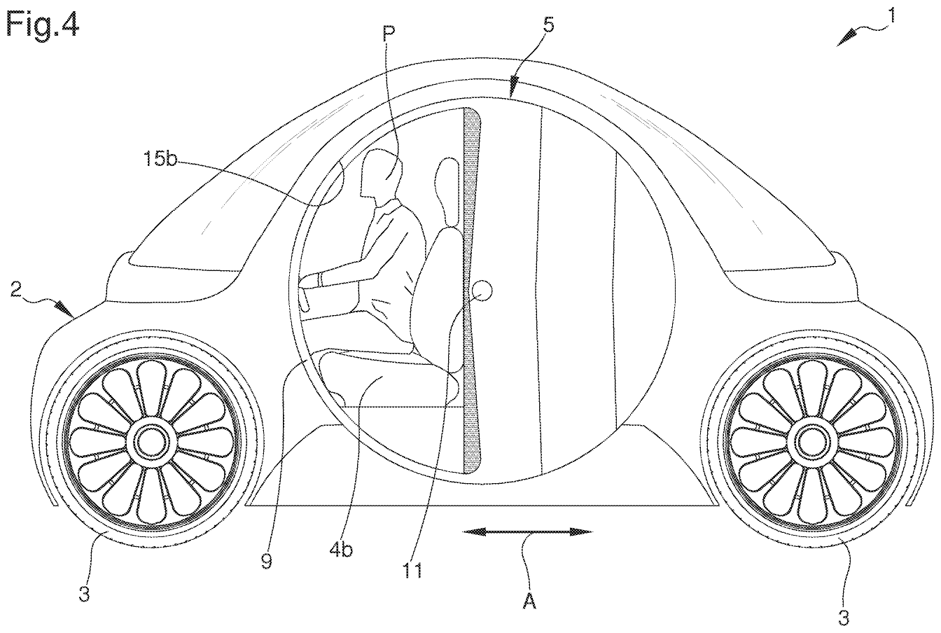

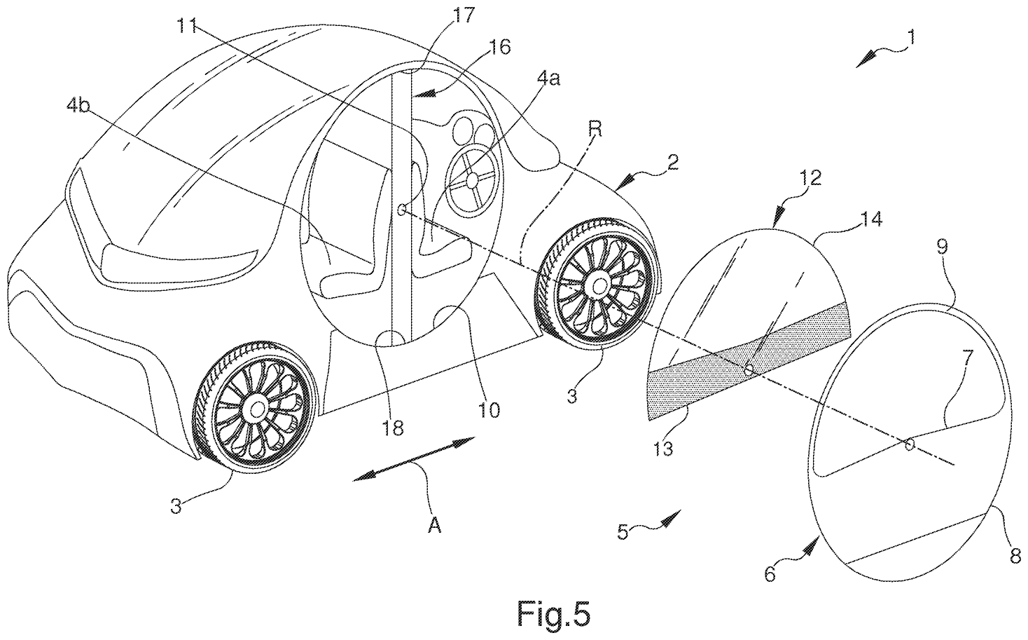

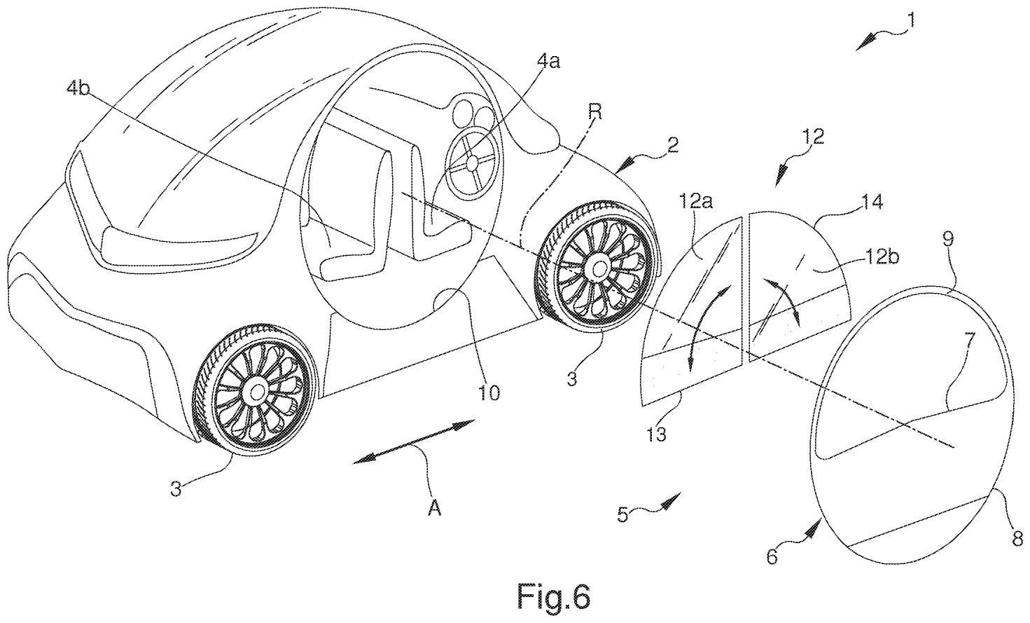

Hybrid solutions between the alternative embodiment just described shown in FIG. 6 and the previous embodiment shown in FIGS. 1 to 5 cannot also be ruled out in this regard.

For example, a motor vehicle 1 cannot be ruled out provided with the vertical upright 16 and also provided with the first portion 12a and with the second portion 12b, or other hybrid solutions still.

It is apparent at this point that, as shown in the figures, the motor vehicle 1 in accordance with the preferred embodiment turns out to be totally symmetrical.

As a result of this symmetry, therefore, the front location 4a and the rear location 4b, as well as the front entrance 15a and the rear entrance 15b, are substantially interchangeable and equivalent to each other.

It is emphasized, in this sense, that the special expedient of making the motor vehicle 1 symmetrically gives numerous advantages.

First, the particular symmetrical conformation of the basic chassis 2 significantly increases the aerodynamic features of the motor vehicle 1, thus reducing its energy consumption while driving.

In addition, such a manufacture of the motor vehicle 1 makes it possible to considerably reduce the number of different components from each other and, in so doing, to lower production costs and its consequent selling price, thus stimulating consumers to purchase.

Not only that, but the smaller number of different components conveniently allows the manufacturing phase of the motor vehicle 1 to be simplified and thus speed up its introduction to the market.

It has in practice been ascertained that the described invention achieves the intended objects.

In the present case, it is emphasized that the particular expedient of providing a car door shaped in a semi-circle and rotating around a horizontal axis of rotation and orthogonal to the anteroposterior direction of standard drive of the motor vehicle allows for easy, practical and functional access/exit into/from the compartment.

This also minimizes the risk of the car door hitting an obstacle in its opening stroke even when the motor vehicle is parked in particularly narrow spaces.

Finally, the special expedient of providing a first and a second opening configuration of the car door allows the latter to be profitably used even in the case of symmetrical motor vehicles that can be driven in both ways, so-called “bidirectional”.

1. Motor vehicle provided with an improved car door, comprising:
at least one basic chassis;
a plurality of wheels associated with said basic chassis and movable along at least one anteroposterior direction for the forward movement of said motor vehicle;
at least one compartment intended to accommodate at least one passenger;
at least one car door associated with said basic chassis so as to be rotatable around at least one axis of rotation substantially horizontal and orthogonal to said anteroposterior direction;
wherein:
said car door comprises at least one opening door provided with at least a first side substantially rectilinear in shape, and with at least a second side, associated with said first side, substantially shaped in a semi-circumference;
said motor vehicle comprises at least one guiding and movement assembly associated with said basic chassis and adapted to move said car door between at least one closing configuration, wherein said first side is arranged substantially horizontal, and at least one opening configuration, wherein said first side is arranged substantially vertical.

2. Motor vehicle according to claim 1, wherein said guiding and movement assembly comprises:
at least one circular rail with which said second side is associated in a sliding manner between said opening configuration and said closing configuration; and
at least one rotational pin around said axis of rotation to which said first side is hinged.

3. Motor vehicle according to claim 2, wherein the curvature of said second side is substantially coincident with the curvature of said circular rail.

4. Motor vehicle according to claim 2, wherein that said rotational pin is arranged in a median position along said first side.

5. Motor vehicle according to claim 1, wherein that said car door comprises at least one window which is associated with at least one of either said opening door or said guiding and movement assembly and is movable between said closing configuration and said opening configuration.

6. Motor vehicle according to claim 5, wherein said window t is provided with:
at least a first stretch which is shaped substantially straight and overlaps substantially mating said first side in said opening configuration and in said closing configuration; and with
at least a second stretch, associated with said first stretch, which is substantially shaped in a semi-circumference and overlaps substantially mating said second side in said opening configuration and alongside said second side in said closing configuration to define a complete circumference with said second side.

7. Motor vehicle according to claim 6, wherein said first stretch is hinged to said rotational pin and that said second stretch is associated with said circular rail in a sliding manner between said closing configuration and said opening configuration.

8. Motor vehicle according to claim 7, wherein said rotational pin is arranged in a median position along said first stretch.

9. Motor vehicle according to claim 7, wherein the curvature of said second stretch is substantially coincident with the curvature of said circular rail.

10. Motor vehicle according to claim 1, wherein:
said basic chassis comprises at least one front entrance and at least one rear entrance where said passenger can pass through for accessing said compartment, said front entrance and said rear entrance being substantially shaped in semi-circles and being side by side to each other to define at least one circular entrance;
said door is associated with said circular entrance and is positionable in at least a first opening configuration wherein it overlaps said rear entrance to allow only said front entrance to pass through, and at least a second opening configuration wherein said car door overlaps said front entrance to allow only said rear entrance to pass through.
